(19) United States
(12) Patent Application Publication
(10) Pub. No.: US 2024/0222802 A1
(43) Pub. Date: Jul. 4, 2024

(54) ENERGY STORAGE BATTERY SYSTEM WITH OVERLAPPING COPPER BUSES

(71) Applicant: James Cheng Lee, La Habra, CA (US)

(72) Inventor: James Cheng Lee, La Habra, CA (US)

(21) Appl. No.: 18/513,732

(22) Filed: Nov. 20, 2023

Related U.S. Application Data
(60) Provisional application No. 63/436,141, filed on Dec. 30, 2022.

(30) Foreign Application Priority Data
Oct. 24, 2023 (CN) 202311379944.X

(51) Int. Cl. H01M 50/522; H01M 50/209; H01M 50/262; H01M 50/271; H01M 50/296; H01M 50/298; H01M 50/507

(52) U.S. Cl. CPC H01M 50/522; H01M 50/209; H01M 50/262; H01M 50/271; H01M 50/296; H01M 50/298; H01M 50/507

(57) ABSTRACT

An energy storage battery system with overlapping copper buses is provided, including a casing, a plurality of battery modules, an upper cover, and a plurality of copper buses. The casing has a positive electrode and a negative electrode. The battery modules are arranged in the casing. The upper cover is disposed in the casing and located above the battery modules. The copper buses are disposed on the upper cover and are electrically connected to the battery modules, the positive electrode and the negative electrode. As such, the copper buses can be arranged according to the shape of the space of the upper cover, thereby achieving the effect of saving space. Furthermore, the copper buses are easy to install on the upper cover and do not require manual arrangement of cables, thereby effectively reducing the assembly process and man-hours.

### BACKGROUND OF THE INVENTION

### 1. Field of the Invention

The present invention relates generally to an energy storage battery system, and more particularly, to an energy storage battery system with overlapping copper buses.

### 2. The Prior Arts

In energy storage battery systems currently on the market, the positive and negative electrodes in the battery modules are connected in series using multiple cables.

However, the cable for connection is flexible. When the cable crosses from the top of the battery module to the top of another battery module, the cable will bend and cannot be arranged nicely according to the space, causing the cable to occupy more space inside of the casing.

Furthermore, the cables may become entangled, making installation more difficult; thereby, the cables must be arranged manually, which increases the assembly process.

In particular, as large-scale energy storage battery systems have larger battery battery modules; also, the larger the battery module is, the greater the current will be, and the thicker the diameter of the cable must be. Therefore, large energy storage battery systems must have enough reserved space and fixing methods to accommodate thick cables and allow the two ends of the thick cables to be fixed on the battery module. However, thick cables take up more space inside the case and are more difficult to install.

### SUMMARY OF THE INVENTION

A primary objective of the present invention is to provide an energy storage battery system that utilizes overlapping copper buses. The copper buses can be configured according to the shape of the space and do not require manual arrangement of wires.

In order to achieve the aforementioned objective, the present invention provides an energy storage battery system with overlapping copper buses, including a casing, a plurality of battery modules, an upper cover, and a plurality of copper buses. The casing has a positive electrode and a negative electrode. The battery modules are arranged in the casing. The upper cover is disposed in the casing and located above the battery modules. The copper buses are disposed on the upper cover and are electrically connected to the battery modules, the positive electrode and the negative electrode.

In a preferred embodiment, a plurality of grooves are provided on a top of the upper cover, and each groove has a first side wall, a second side wall, a third side wall, and a fourth side wall; the second side wall is located opposite to the first side wall, and the fourth side wall is located opposite to the third side wall; wherein, each copper bus comprises a main body and at least one plate body, and the main body is disposed on the first side wall and electrically connected to the positive electrode and the negative electrode, the at least one plate body is disposed on at least one side of the main body, located in at least one of the grooves, and electrically connected to each of the battery modules.

In a preferred embodiment, the first side wall is provided with at least one fixing hole, and each copper bus further comprises at least one fixing part; the at least one fixing part is disposed at a bottom of the main body and is fixed to the at least one fixing hole after being heat fusion.

In a preferred embodiment, the at least one fixing hole comprises an upper part and a lower part, and a diameter of the upper part is greater than a diameter of the lower part; wherein the at least one fixing part comprises a connecting part and a barb part, the connecting part is provided between the main body and the barb part; wherein, before performing heat fusion, the connecting part is located outside the upper part, and the barb part is located in the upper part; wherein, during performing heat fusion, the first side wall is in a molten state and the main body is pressurized, so that the barb part moves to the lower part, the outside of the barb part enters the first side wall, and the connecting part moves to the upper part; wherein, after completing heat fusion, the first side wall is cooled and solidified, so that the barb part is fixed in the first side wall.

In a preferred embodiment, both sides of the barb part have at least one protrusion respectively.

In a preferred embodiment, the at least one fixing hole is located at at least one end of the first side wall, and the at least one fixing part is located at at least one end of the main body.

In a preferred embodiment, at least one positioning post is provided on an inner side of at least one of the third side wall and the fourth side wall, and at least one positioning hole is provided on at least one side of the at least one plate body, and the at least one positioning post is located in the at least one positioning hole.

In a preferred embodiment, a bottom of each groove is provided with a first through hole, the at least one plate body is provided with a second through hole, and the first through hole communicates with the second through hole; wherein, the top of each of the battery modules has a battery tab and a plurality of metal strips; the battery tab is located below the first through hole and the second through hole; the metal strips pass through the first through hole and the second through hole; and two ends of the metal strips are respectively welded to the battery tab and the at least one plate body.

In a preferred embodiment, each metal strip is made of aluminum, and the two ends of the metal strips are respectively welded to the battery tab and the at least one plate body by ultrasonic waves.

In a preferred embodiment, the main body is provided with a plurality of through holes, and the through holes are used for the ends of a plurality of cables to be locked therein; the cables are respectively connected to the positive electrode and the negative electrode.

The effect of the present invention is that the copper buses can be arranged according to the shape of the space of the upper cover, thereby achieving the effect of saving space.

Furthermore, the copper buses are easy to install on the upper cover and do not require manual arrangement of cables, thereby effectively reducing the assembly process and man-hours.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of the system of the present invention.

FIG. 2 is a top view of the system of the present invention.

FIG. 3 is a schematic view of area A of FIG. 1.

FIG. 4 is an exploded view of the system of the present invention.

FIG. 5 is a schematic view of area B of FIG. 4.

FIG. 6 is a perspective view of the copper bus of the system of the present invention.

FIG. 7 is a perspective view of another copper bus of the system of the present invention.

FIG. 8 is a cross-sectional view of the upper cover and the copper bus of the system of the present invention before heat fusion.

FIG. 9 is a cross-sectional view of the upper cover and the copper bus of the system of the present invention after heat fusion.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

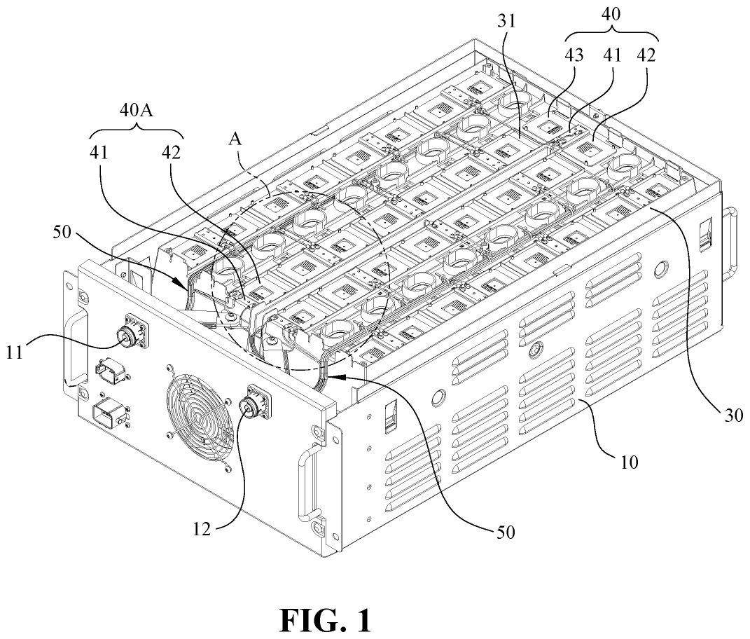

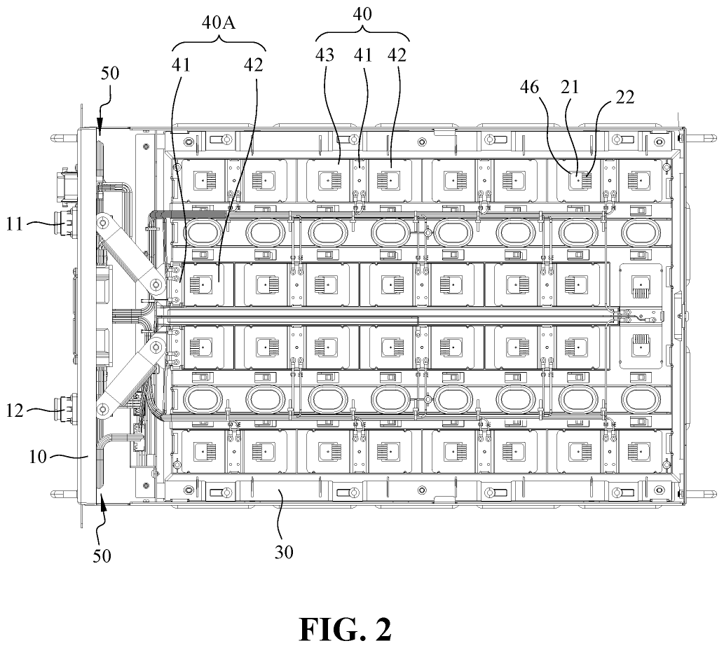

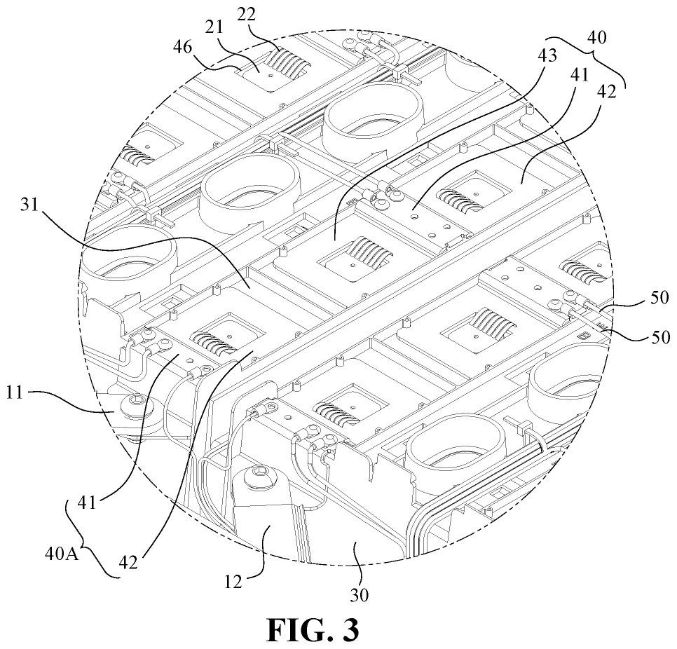

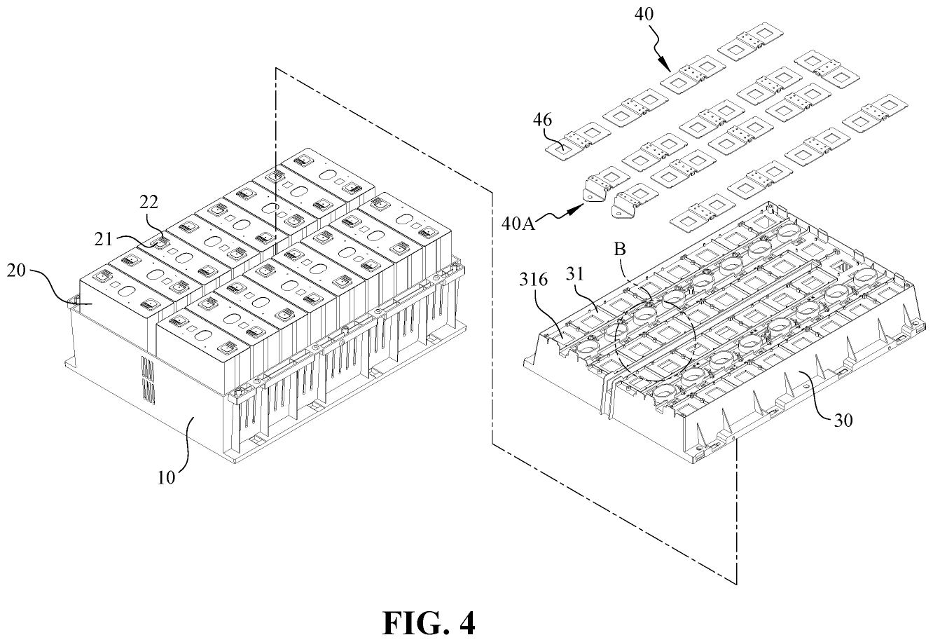

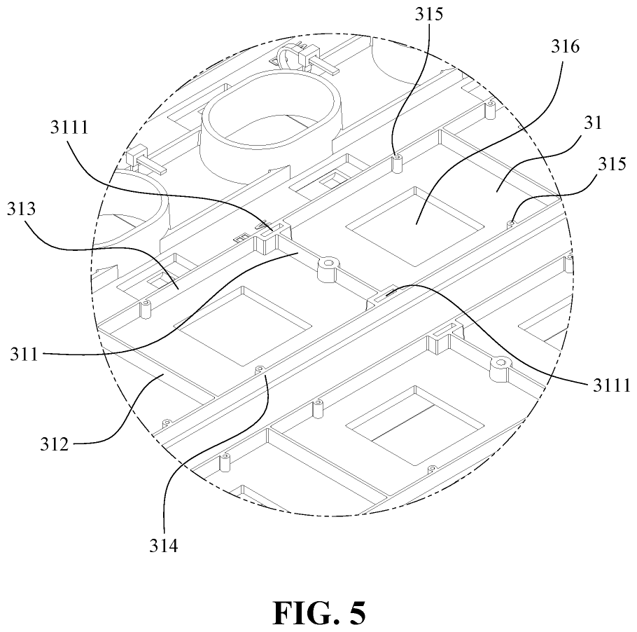

FIG. 1 is a perspective view of the system of the present invention, FIG. 2 is a top view of the system of the present invention, FIG. 3 is a schematic view of area A of FIG. 1, FIG. 4 is an exploded view of the system of the present invention, and FIG. 5 is a schematic view of area B of FIG. 4. As shown in FIGS. 1 to 5, the present invention provides an energy storage battery system with overlapping copper buses, including a casing 10, a plurality of battery modules 20, an upper cover 30, and a plurality of copper buses 40, 40A. The casing 10 has a positive electrode 11 and a negative electrode 12. The battery modules 20 are arranged in the casing 10. The upper cover 30 is disposed in the casing 10 and located above the battery modules 20. The copper buses 40 and 40A are disposed on the upper cover 30 and are electrically connected to the battery modules 20, the positive electrode 11, and the negative electrode 12. Thereby, the copper buses 40 and 40A can be arranged according to the shape of the space of the upper cover 30 to achieve a space-saving effect. Furthermore, the copper buses 40 and 40A are easily installed on the upper cover 30 and do not require manual arrangement of cables, thereby effectively reducing the assembly process and man-hours.

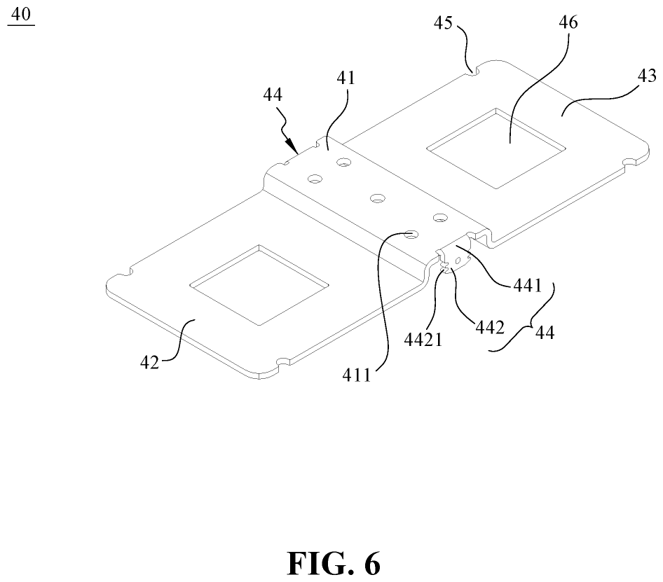

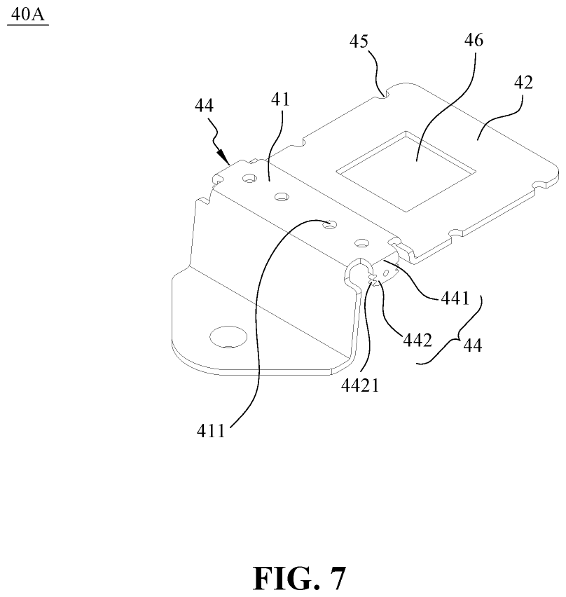

As shown in FIGS. 4 and 5, in a preferred embodiment, a plurality of grooves 31 are formed on a top of the upper cover 30. Each groove 31 has a first side wall 311, a second side wall 312, a third side wall 313, and a fourth side wall 314. The second side wall 312 is located opposite to the first side wall 311, and the fourth side wall 312 is located opposite to the third side wall 313. FIG. 6 is a perspective view of the copper bus 40 of the system of the present invention. As shown in FIGS. 3 and 6, the copper bus 40 includes a main body 41 and two plate bodies 42 and 43. The main body 41 is disposed on the first side wall 311 and is electrically connected to the positive electrode 11 and the negative electrode 12. The plate bodies 42, 43 are respectively provided on two sides of the main body 41, located in two of the grooves 31, and electrically connected to the battery modules 20. FIG. 7 is a perspective view of another copper bus 40A of the system of the present invention. As shown in FIGS. 3 and 7, the copper bus 40A includes a main body 41 and a plate body 42. The main body 41 is disposed on the first side wall 311 and is electrically connected to the positive electrode 11 and the negative electrode 12. The plate body 42 is disposed on one side of the main body 41, located in one of the grooves 31, and electrically connected to the battery module 20, and the other side of the main body 41 is connected to the positive electrode 11 or the negative electrode 12 (see FIGS. 1 to 3). Thereby, the main body 41 and the plate bodies 42 and 43 of the copper bus 40 as well as the main body 41 and the plate body 42 of the copper bus 40A can be arranged according to the shape of the first side wall 311 and the space of the grooves 31 of the upper cover 30, so as to achieve space-saving effect. Furthermore, the main body 41 and the plate bodies 42 and 43 of the copper bus 40 as well as the main body 41 and the plate body 42 of the copper bus 40A are installed on the first side wall 311 and the grooves 31 of the upper cover 30 in a simple way without the need for manually arranging the cables, thereby, effectively reducing the assembly process and man-hours.

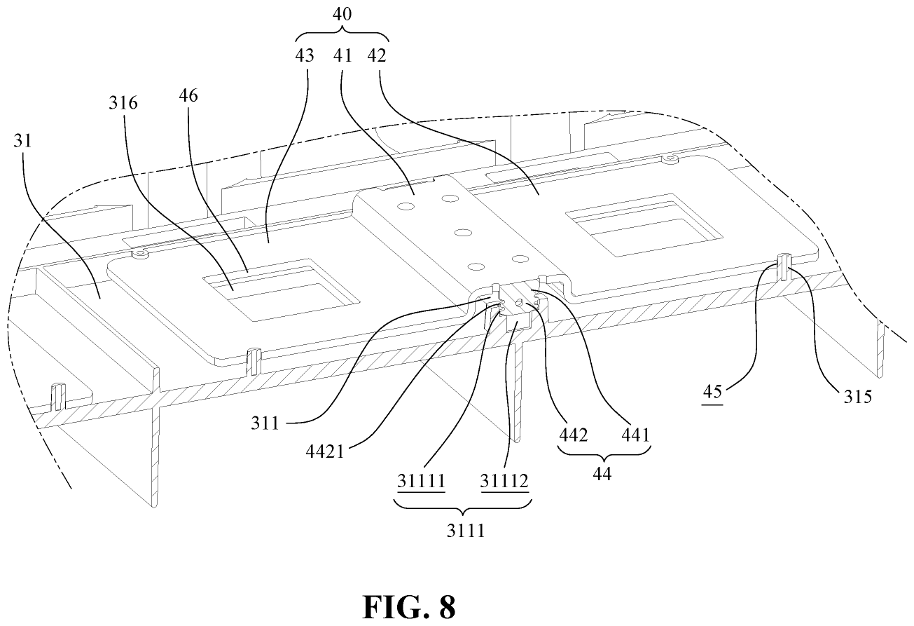

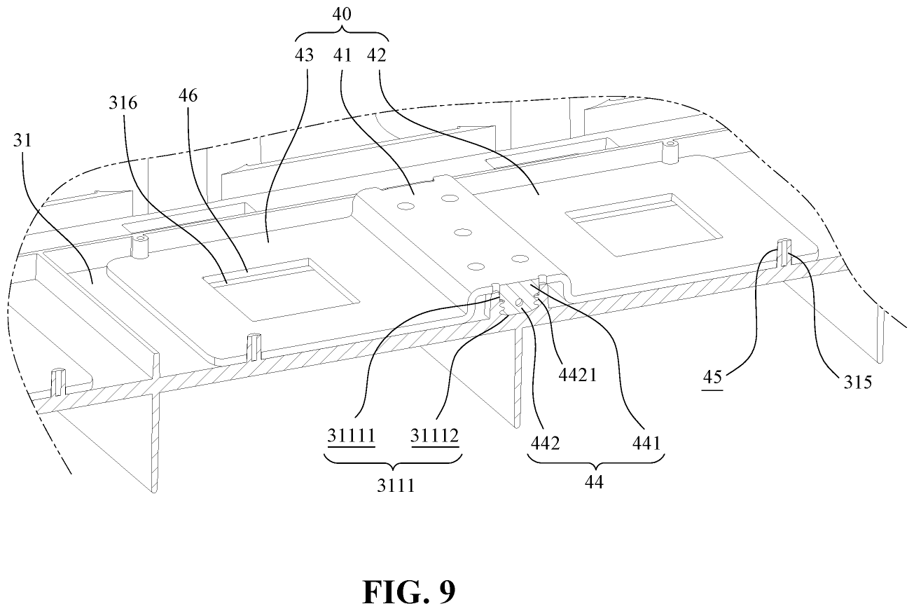

As shown in FIGS. 5, 6 and 7, in a preferred embodiment, the first side wall 311 is provided with two fixing holes 3111, and each copper bus 40, 40A further includes two fixing parts 44. These fixing parts 44 are provided at the bottom of the main body 41. FIG. 8 is a cross-sectional view of the upper cover 30 and the copper bus 40 of the system of the present invention before heat fusion is performed. FIG. 9 is a cross-sectional view of the upper cover 30 and the copper bus 40 of the system of the present invention after heat fusion is performed. As shown in FIGS. 8 and 9, the fixing parts 44 are fixed in the fixing holes 3111 after heat fusion. As such, the system of the present invention can modularize the upper cover 30 and the copper buses 40 and 40A through heat fusion treatment, which is simple and does not require manual arrangement of cables, effectively reducing the assembly process and man-hours.

Specifically, as shown in FIG. 8, each fixing hole 3111 includes an upper part 31111 and a lower part 31112. The diameter of the upper part 31111 is larger than the diameter of the lower part 31112. As shown in FIGS. 6 and 7, each fixing part 44 includes a connecting part 441 and a barb part 442. The connecting part 441 is disposed between the main body 41 and the barb part 442. As shown in FIG. 8, before the heat fusion process is performed, the connecting part 441 is located at the outer side of the upper part 31111 and the barb part 442 is located in the upper part 31111. During the heat fusion process, the first side wall 311 is in a molten state, and the main body 41 is pressurized, so that the barb part 442 moves to the lower part 31112 and its outer side enters the first side wall 311, and the connecting part 441 moves in to the upper part 31111. As shown in FIG. 9, after the heat fusion process is completed, the first side wall 311 is cooled and solidified, so that the barb part 442 is fixed in the first side wall 311. Therefore, the barb part 442 can increase the contact area between its outer side and the first side wall 311, thereby improving the effect of the fixing part 44 being fixed to the fixing hole 3111.

Preferably, as shown in FIGS. 6 and 7, the two sides of the barb part 442 have two protrusions 4421 respectively. Therefore, these protrusions 4421 can increase the contact area between the outer side of the barb part 442 and the first side wall 311, thereby improving the effect of fixing the fixing part 44 to the fixing hole 3111.

Preferably, as shown in FIG. 5, the fixing holes 3111 are located at both ends of the first side wall 311. As shown in FIGS. 6 and 7, the fixing parts 44 are located at two ends of the main body 41. Thereby, the effect of fixing the copper buses 40 and 40A to the upper cover 30 is more stable.

Preferably, as shown in FIG. 5, the third side wall 313 and the fourth side wall 314 each has a positioning post 315 on the inside. As shown in FIG. 6, one positioning hole 45 is provided on both sides of each plate body 42 and 43 of the copper bus 40. As shown in FIG. 7, two positioning holes 45 are respectively formed on two sides of the plate body 42 of the copper bus 40A. As shown in FIG. 8, before the heat fusion process is performed, each plate body 42 and 43 is located above each groove 31, and the tops of the positioning posts 315 are located in the positioning holes 45. During the heat fusion process, each plate body 42 and 43 will move downward along the positioning posts 315. As shown in FIG. 9, after the heat fusion process is completed, each plate body 42 and 43 enters each groove 31, and the bottoms of the positioning posts 315 are located in the positioning holes 45. Thereby, the positioning posts 315 can assist each plate body 42 and 43 to accurately align with the groove 31 and move into the groove 31 smoothly.

Preferably, the upper cover 30 is made of plastic, and plastic can be in a molten state in a high temperature environment.

As shown in FIGS. 5, 6 and 7, in a preferred embodiment, a first through hole 316 is provided at the bottom of each groove 31, and a second through hole 46 is provided in each plate body 42, 43. As shown in FIGS. 8 and 9, the first through hole 316 communicates with the second through hole 46. As shown in FIG. 4, the top of each battery module 20 has a battery tab 21 and a plurality of metal strips 22. As shown in FIG. 1, FIG. 2, and FIG. 3, the battery tab 21 is located below the first through hole 316 and the second through hole 46, and the metal strips 22 pass through the first through hole 316 and the second through hole 46. The two ends of the metal strips 22 are respectively welded to the battery tab 21 and each plate body 42, 43. Therefore, the copper buses 40 and 40A and the battery tabs 21 can be electrically connected through the metal strips 22 without any obstruction.

Preferably, the metal strips 22 are made of aluminum, and the two ends of the metal strips 22 are respectively welded to the battery tabs 21 and each plate body 42, 43 by ultrasonic waves.

As shown in FIGS. 6 and 7, in a preferred embodiment, the main body 41 is provided with a plurality of through holes 411. As shown in FIG. 3, the through holes 411 are used for the ends of a plurality of cables 50 to be locked therein. As shown in FIGS. 1 and 2, the cables 50 are connected to the positive electrode 11 and the negative electrode 12 respectively.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An energy storage battery system with overlapping copper buses, comprising:
a casing, having a positive electrode and a negative electrode;
a plurality of battery modules, arranged in the casing;
an upper cover, disposed in the casing and located above the battery modules; and
a plurality of copper buses, disposed on the upper cover and electrically connected to the battery modules, the positive electrode and the negative electrode.

2. The energy storage battery system with overlapping copper buses according to claim 1, wherein a plurality of grooves are provided on a top of the upper cover, and each groove has a first side wall, a second side wall, a third side wall, and a fourth side wall; the second side wall is located opposite to the first side wall, and the fourth side wall is located opposite to the third side wall; wherein, each copper bus comprises a main body and at least one plate body, and the main body is disposed on the first side wall and electrically connected to the positive electrode and the negative electrode, the at least one plate body is disposed on at least one side of the main body, located in at least one of the grooves, and electrically connected to each of the battery modules.

3. The energy storage battery system with overlapping copper buses according to claim 2, wherein the first side wall is provided with at least one fixing hole, and each copper bus further comprises at least one fixing part; the at least one fixing part is disposed at a bottom of the main body and is fixed to the at least one fixing hole after being heat fusion.

4. The energy storage battery system with overlapping copper buses according to claim 3, wherein the at least one fixing hole comprises an upper part and a lower part, and a diameter of the upper part is greater than a diameter of the lower part; wherein the at least one fixing part comprises a connecting part and a barb part, the connecting part is provided between the main body and the barb part; wherein, before performing heat fusion, the connecting part is located outside the upper part, and the barb part is located in the upper part; wherein, during performing heat fusion, the first side wall is in a molten state and the main body is pressurized, so that the barb part moves to the lower part, the outside of the barb part enters the first side wall, and the connecting part moves to the upper part; wherein, after completing heat fusion, the first side wall is cooled and solidified, so that the barb part is fixed in the first side wall.

5. The energy storage battery system with overlapping copper buses according to claim 4, wherein both sides of the barb part have at least one protrusion respectively.

6. The energy storage battery system with overlapping copper buses according to claim 3, wherein the at least one fixing hole is located at at least one end of the first side wall, and the at least one fixing part is located at at least one end of the main body.

7. The energy storage battery system with overlapping copper buses according to claim 3, wherein at least one positioning post is provided on an inner side of at least one of the third side wall and the fourth side wall, and at least one positioning hole is provided on at least one side of the at least one plate body, and the at least one positioning post is located in the at least one positioning hole.

8. The energy storage battery system with overlapping copper buses according to claim 2, wherein a bottom of each groove is provided with a first through hole, the at least one plate body is provided with a second through hole, and the first through hole communicates with the second through hole; wherein, the top of each of the battery modules has a battery tab and a plurality of metal strips; the battery tab is located below the first through hole and the second through hole; the metal strips pass through the first through hole and the second through hole; and two ends of the metal strips are respectively welded to the battery tab and the at least one plate body.

9. The energy storage battery system with overlapping copper buses according to claim 8, wherein the metal strips are made of aluminum, and the two ends of the metal strips are respectively welded to the battery tab and the at least one plate body by ultrasonic waves.

10. The energy storage battery system with overlapping copper buses according to claim 2, wherein the main body is provided with a plurality of through holes, and the through holes are used for the ends of a plurality of cables to be locked therein; the cables are respectively connected to the positive electrode and the negative electrode.
